(19) United States
(12) Patent Application Publication
(10) Pub. No.: US 2023/0384628 A1
(43) Pub. Date: Nov. 30, 2023

(54) OPTICAL ELEMENT AND DISPLAY DEVICE

(71) Applicant: Japan Display Inc., Tokyo (JP)

(72) Inventors: Toshiharu MATSUSHIMA, Tokyo (JP); Shunichi KIMURA, Tokyo (JP)

(73) Assignee: Japan Display Inc., Tokyo (JP)

(21) Appl. No.: 18/323,475

(22) Filed: May 25, 2023

(30) Foreign Application Priority Data
May 26, 2022 (JP) 2022-086302

(51) Int. Cl. G02F 1/13; G02F 1/1335; G02F 1/1343

(52) U.S. Cl. CPC G02F 1/1323; G02F 1/133531; G02F 1/134309

(57) ABSTRACT

According to an aspect, an optical element includes: a first polarizing plate having a first absorption axis; a second polarizing plate facing the first polarizing plate and having a second absorption axis; and a first viewing angle control panel placed between the first polarizing plate and the second polarizing plate. The first viewing angle control panel includes: a first substrate; a second substrate facing the first substrate; a liquid crystal layer provided between the first substrate and the second substrate; and a plurality of electrodes provided on at least one of the first substrate and the second substrate to generate a transverse electric field in a predetermined direction. The liquid crystal layer includes liquid crystal molecules with a positive dielectric anisotropy. The liquid crystal molecules have hybrid orientation in a state in which the transverse electric field is not generated.

### CROSS-REFERENCE TO RELATED APPLICATION

This application claims the benefit of priority from Japanese Patent Application No. 2022-086302 filed on May 26, 2022, the entire contents of which are incorporated herein by reference.

### BACKGROUND

### 1. Technical Field

What is disclosed herein relates to an optical element and a display device.

### 2. Description of the Related Art

Display devices each including an optical element to control a viewing angle have been known. Such a display device includes an optical element (e.g., a viewing angle control cell) to ensure a wide viewing angle of a display panel when a voltage is applied and reduce the brightness in the left and right direction when no voltage is applied. The optical element includes a pair of light-transmitting substrates and a liquid crystal layer. The liquid crystal layer is placed between the pair of light-transmitting substrates and includes hybrid-oriented liquid crystal molecules. For the liquid crystal molecules in the liquid crystal layer, a material having a negative dielectric anisotropy is used.

Liquid crystal layers having liquid crystal molecules with a negative dielectric anisotropy is more viscous than liquid crystal layers having liquid crystal molecules with a positive dielectric anisotropy, which may degrade the response speed to voltage on/off switching. By contrast, liquid crystal layers having liquid crystal molecules with a positive dielectric anisotropy may have degradation in viewing angle characteristics when a voltage is applied, which requires a viewing angle correcting filter, such as a C plate. Therefore, an optical element is desirable that is capable of controlling a viewing angle with a simpler configuration while a liquid crystal layer having liquid crystal molecules with a positive dielectric anisotropy is used.

### SUMMARY

According to an aspect, an optical element includes: a first polarizing plate having a first absorption axis; a second polarizing plate facing the first polarizing plate and having a second absorption axis; and a first viewing angle control panel placed between the first polarizing plate and the second polarizing plate. The first viewing angle control panel includes: a first substrate; a second substrate facing the first substrate; a liquid crystal layer provided between the first substrate and the second substrate; and a plurality of electrodes provided on at least one of the first substrate and the second substrate to generate a transverse electric field in a predetermined direction. The liquid crystal layer includes liquid crystal molecules with a positive dielectric anisotropy. The liquid crystal molecules have hybrid orientation in a state in which the transverse electric field is not generated.

According to an aspect, a display device includes: the optical element; a display panel stacked with the optical element; and a lighting device configured to irradiate the optical element with light.

### BRIEF DESCRIPTION OF THE DRAWINGS

FIG. 1 is a sectional view schematically illustrating a display device according to a first embodiment;

FIG. 2 is a sectional view schematically illustrating an example of a configuration of a display panel according to the first embodiment;

FIG. 3 is a sectional view schematically illustrating an example of a configuration of an optical element according to the first embodiment;

FIG. 4 is a plan view illustrating first and second electrodes of a first viewing angle control panel;

FIG. 5 is a diagram for explaining the relation between the direction of absorption axes of polarizing plates and the direction of orientation of a liquid crystal layer of the first viewing angle control panel in the display device according to the first embodiment;

FIG. 6 is a graph illustrating the relation between the brightness and the polar angle in display devices according to a first example and a second example;

FIG. 7 is a diagram illustrating viewing angle dependence of the brightness in a first state of the display device according to the first example;

FIG. 8 is a diagram illustrating viewing angle dependence of the brightness in a second state of the display device according to the first example;

FIG. 9 is a diagram illustrating viewing angle dependence of the brightness in a second state of the display device according to the second example;

FIG. 10 is a sectional view schematically illustrating an example of a configuration of an optical element according to a first modification;

FIG. 11 is a sectional view schematically illustrating an example of a configuration of an optical element according to a second modification;

FIG. 12 is a sectional view schematically illustrating a display device according to a second embodiment;

FIG. 13 is a diagram for explaining the relation between the direction of absorption axes of the polarizing plates and the direction of orientation of the liquid crystal layer of the first viewing angle control panel in the display device according to the second embodiment;

FIG. 14 is a sectional view schematically illustrating a display device according to a third modification of the second embodiment; and

FIG. 15 is a diagram for explaining the relation between the direction of absorption axes of the polarizing plates and the direction of orientation of the liquid crystal layer of the first viewing angle control panel in the display device according to the third modification of the second embodiment.

### DETAILED DESCRIPTION

Embodiments of the present disclosure will be described in detail with reference to the drawings. The description of the following embodiments does not limit the present disclosure. Components described below include those that could be easily assumed by a person skilled in the art and those that are substantially the same. Furthermore, the components described below can be combined as appropriate. The disclosure is merely an example, and, as may be understood, the scope of the present disclosure includes any modification that a person skilled in the art could easily conceive of and that could be made as appropriate while the spirit of the present disclosure is maintained. Although the width, the thickness, the shape, and the like of constituents may be schematically represented in the drawings as compared with the actual aspect in order to clarify the explanation, it is merely an example and does not limit the interpretation of the present disclosure. In the present disclosure and the drawings, the same reference signs are given to the same components as those described earlier for the drawings that have been previously presented, and detailed description thereof may be omitted as appropriate.

In the present specification and the claims, in describing an aspect in which, on one structure or above one structure, another structure is placed, the term “on” simply shall include both cases in which another structure is placed directly on one structure in such a manner as to come into contact with the one structure, and in which another structure is placed above one structure with still another structure therebetween, unless otherwise specified.

### First Embodiment

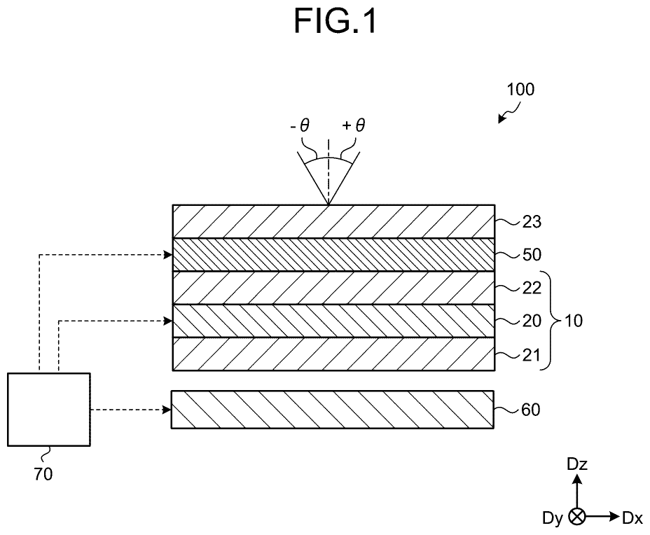

FIG. 1 is a sectional view schematically illustrating a display device according to a first embodiment. As illustrated in FIG. 1, a display device 100 includes an optical element 10, a display panel 50, a third polarizing plate 23, a lighting device 60, and a control circuit 70.

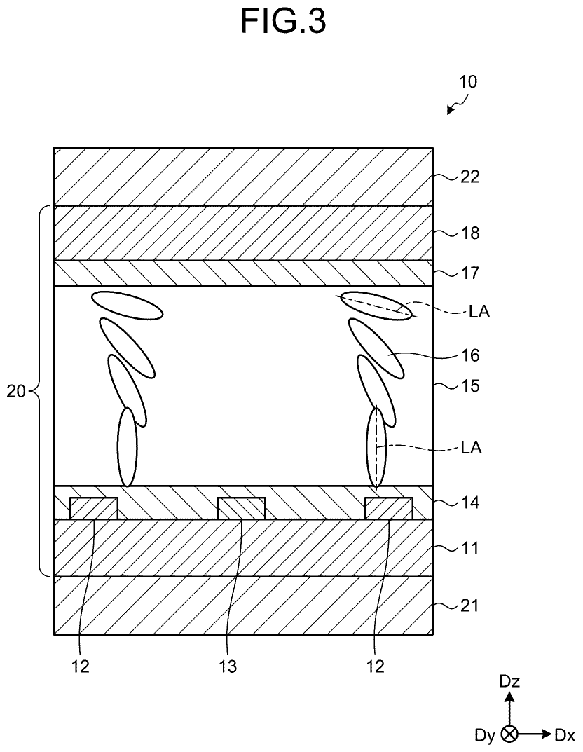

The optical element 10 is placed between the lighting device 60 and the display panel 50 in a direction (third direction Dz) perpendicular to a display surface of the display panel 50. The optical element 10 includes a first polarizing plate 21, a second polarizing plate 22, and a first viewing angle control panel 20 placed between the first and second polarizing plates 21 and 22. The optical element 10 includes the second polarizing plate 22, the first viewing angle control panel 20, and the first polarizing plate 21 stacked in this order, from the lighting device 60 to the display panel 50, in the third direction Dz. The detailed configuration of the optical element 10 will be described later in FIG. 3 and the following figures.

In the following description, a first direction Dx is one direction in a plane parallel to the surface of the optical element 10 (i.e., the surface of the first polarizing plate 21). A second direction Dy is one direction in the plane parallel to the surface of the optical element 10 and orthogonal to the first direction Dx. The second direction Dy may intersect the first direction Dx without being orthogonal to the first direction Dx. The third direction Dz is orthogonal to the first direction Dx and the second direction Dy. The third direction Dz is the direction normal to the surface of the optical element 10. The third direction Dz can be rephrased as the normal direction of the display surface of the display panel 50. The term “plan view” refers to the positional relation when viewed in a direction perpendicular to the surface of the optical element 10.

In the following description, the direction from the first polarizing plate 21 to the third polarizing plate 23 in the direction perpendicular to the surface of the optical element 10 is referred to as “upper side” or simply “up”. The direction from the third polarizing plate 23 to the first polarizing plate 21 is referred to as “lower side” or simply “down”.

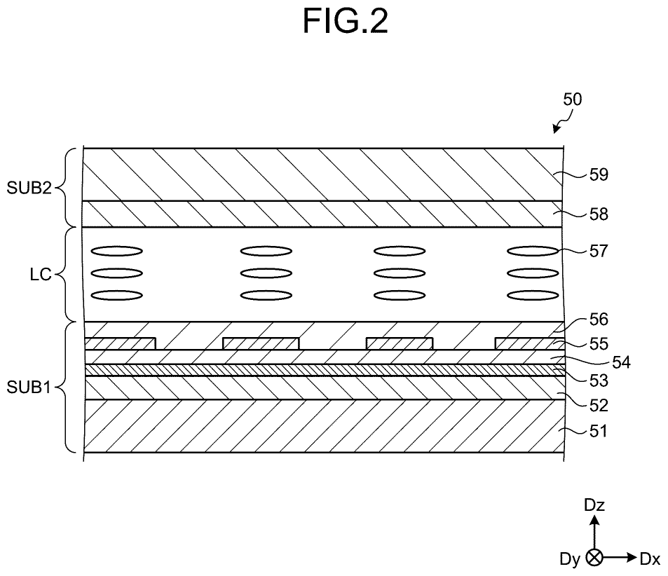

The display panel 50 is a liquid crystal display panel including a liquid crystal layer LC (see FIG. 2) as a display function layer. The display panel 50 is stacked facing the optical element 10. More specifically, the display panel 50 faces the first viewing angle control panel 20 with the second polarizing plate 22 therebetween. The third polarizing plate 23 is provided on the display surface side of the display panel 50.

The lighting device 60 is a backlight unit. The lighting device 60 may be of any configuration. For example, an edge-light type backlight or a direct-light type backlight can be applied. An edge-light type backlight includes a light source such as a light emitting diode (LED) and a light guiding plate, and the LED is provided at an edge of the light guiding plate. In a direct-light type backlight, an LED is provided directly under a diffusion plate.

The control circuit 70 is electrically coupled to the display panel 50, the first viewing angle control panel 20, and the lighting device 60 individually, and is configured to control the driving of the display panel 50, the first viewing angle control panel 20, and the lighting device 60.

In the display device 100 of the present embodiment, the lighting device 60 emits diffused light toward the optical element 10. The first viewing angle control panel 20 of the optical element 10 is a viewing angle control element that adjusts the viewing angle dependence of light incident from the lighting device 60 to inhibit light transmission in a particular direction. More specifically, the first viewing angle control panel 20, together with the first polarizing plate 21 and the second polarizing plate 22, switches a control state between a first state in which light incident from the lighting device 60 is inhibited from being transmitted in a particular direction and a second state in which the light incident from the lighting device 60 is emitted as diffused light. In other words, the optical element 10 emits light with higher directivity in the first state than in the second state.

Light transmitted through the optical element 10 enters the display panel 50. In the first state, the display panel 50 displays an image the brightness of which is held low in a particular direction. In the second state, the display panel 50 displays an image with a wider viewing angle than in the first state.

In the following description, a polar angle θ is the angle made with respect to the direction parallel to the third direction Dz. The polar angle θ in the direction parallel to the third direction Dz is 0°. In FIG. 1, the polar angle θ on the right side (one side of the first direction Dx) with respect to the third direction Dz may be expressed as positive (+θ), and the polar angle θ on the left side (the other side of the first direction Dx) with respect to the third direction Dz as negative (−θ).

The layers of the display device 100, that is, the first polarizing plate 21, the first viewing angle control panel 20, the second polarizing plate 22, the display panel 50, and the third polarizing plate 23, are bonded by a light-transmitting adhesive layer (not illustrated). However, the display device 100 is not limited thereto, and no adhesive layers may be provided between the layers of the optical element 10, the display panel 50, and the third polarizing plate 23; and the layers may be stacked with an air layer therebetween.

In the present embodiment, the second polarizing plate 22 of the optical element 10 is also used as a polarizing plate on the rear side of the display panel 50. In other words, the single second polarizing plate 22 is placed between the display panel 50 and the first viewing angle control panel 20 of the optical element 10. This improves the light transmittance compared with a configuration in which a polarizing plate for the display panel 50 is provided in addition to the second polarizing plate 22 of the optical element 10 on the rear side of the display panel 50.

The following describes a configuration of the display panel 50. FIG. 2 is a sectional view schematically illustrating an example of the configuration of the display panel according to the first embodiment. The display panel 50 includes, for example, an array substrate SUB1, a counter substrate SUB2, and the liquid crystal layer LC as a display functional layer. The counter substrate SUB2 is placed facing the array substrate SUB1. The liquid crystal layer LC is enclosed between the array substrate SUB1 and the counter substrate SUB2.

The array substrate SUB1 includes a first insulating substrate 51, a circuit formation layer 52, a common electrode 53, an insulating film 54, pixel electrodes 55, and a lower orientation film 56. In the third direction Dz, the circuit formation layer 52, the common electrode 53, the insulating film 54, the pixel electrodes 55, and the lower orientation film 56 are stacked in this order on the first insulating substrate 51.

The first insulating substrate 51 is a light-transmitting glass or film substrate. The circuit formation layer 52 is a layer in which a pixel circuit including a plurality of thin-film transistors as switching elements and various wiring is formed. The common electrode 53 is an electrode to which a predetermined constant potential is given. The insulating film 54 insulates the common electrode 53 and the pixel electrodes 55 from each other. Different pixel electrodes 55 are provided for different pixels, and their respective potentials are individually controlled. The lower orientation film 56 is provided to cover the pixel electrodes 55 and the insulating film 54.

The counter substrate SUB2 includes a second insulating substrate 59 and an upper orientation film 58. The surface of the second insulating substrate 59 facing the first insulating substrate 51 is provided with the upper orientation film 58. The upper orientation film 58 is the surface of the liquid crystal layer LC side of the counter substrate SUB2. Although the illustration is omitted in FIG. 2, the counter substrate SUB2 is provided with a color filter or light-shielding film as necessary.

The liquid crystal layer LC modulates light passing therethrough in accordance with the state of the electric field. For example, liquid crystals in the transverse electric field mode such as in-plane switching (IPS) including fringe field switching (FFS) are used. In the present embodiment, the liquid crystal layer LC is driven by a transverse electric field generated between the pixel electrodes 55 and the common electrode 53 provided in the array substrate, and the orientation of liquid crystal molecules 57 in the liquid crystal layer LC is controlled.

However, the display panel 50 is not limited to this aspect and may be a liquid crystal display panel of the vertical field type. In this case, the pixel electrodes are provided in the array substrate and the common electrode is provided in the counter substrate. Examples of liquid crystal display panels of the vertical field type include, but are not limited to, those of twisted nematic (TN), vertical alignment (VA) and electrically controlled birefringence (ECB), etc., in which a vertical electric field is applied to the liquid crystal layer.

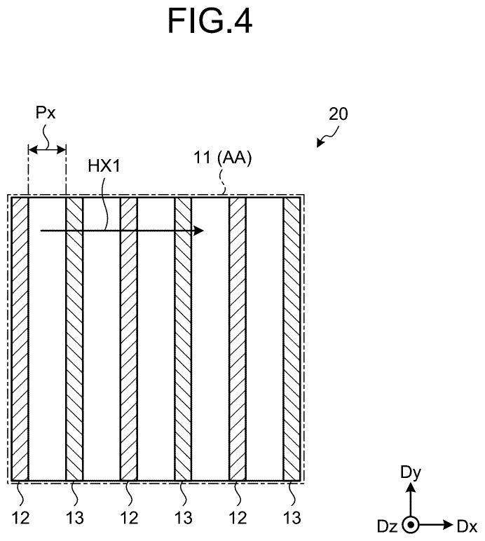

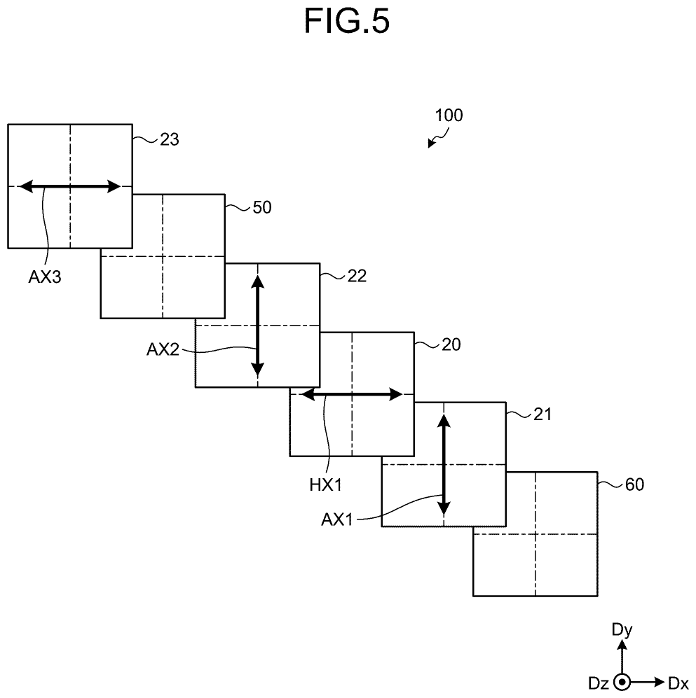

The following describes the detailed configuration of the optical element 10. FIG. 3 is a sectional view schematically illustrating an example of the configuration of the optical element according to the first embodiment. FIG. 4 is a plan view illustrating first and second electrodes of the first viewing angle control panel. FIG. 5 is a diagram for explaining the relation between the direction of absorption axes of the polarizing plates and the direction of orientation of the liquid crystal layer of the first viewing angle control panel in the display device according to the first embodiment.

As illustrated in FIGS. 3 and 5, the first and second polarizing plates 21 and 22 are linear polarizing plates. The first polarizing plate 21 has a first absorption axis AX1 extending in a direction parallel to the second direction Dy. The second polarizing plate 22 faces the first polarizing plate 21 and has a second absorption axis AX2 extending in a direction parallel to the second direction Dy. In plan view, the first absorption axis AX1 of the first polarizing plate 21 is parallel to the second absorption axis AX2 of the second polarizing plate 22. Although the illustration is omitted, the first polarizing plate 21 has a first easy transmission axis orthogonal to the first absorption axis AX1. The second polarizing plate 22 has a second easy transmission axis orthogonal to the second absorption axis AX2.

The third polarizing plate 23 provided on the display surface side of the display panel 50 has a third absorption axis AX3 and a third easy transmission axis orthogonal to the third absorption axis AX3. The third absorption axis AX3 and the third easy transmission axis of the third polarizing plate 23 are provided in a predetermined direction in plan view depending on the display mode of the display panel 50. In the example illustrated in FIG. 5, the third absorption axis AX3 of the third polarizing plate 23 is orthogonal to the second absorption axis AX2 of the second polarizing plate 22 in plan view.

As illustrated in FIG. 3, the first viewing angle control panel 20 includes a first substrate 11, a plurality of first electrodes 12 and a plurality of second electrodes 13, a first orientation film 14, a liquid crystal layer 15, a second orientation film 17, and a second substrate 18. The first polarizing plate 21, the first substrate 11, the first electrodes 12 and the second electrodes 13, the first orientation film 14, the liquid crystal layer 15, the second orientation film 17, the second substrate 18, the second polarizing plate 22 are stacked in this order in the third direction Dz.

The first substrate 11 is provided on the upper side of the first polarizing plate 21. The first substrate 11 is a light-transmitting insulating substrate and is formed, for example, of glass or resin. The first electrodes 12 and the second electrodes 13 are provided on the top surface of the first substrate 11, that is, the surface of the first substrate 11 facing the second substrate 18. The first electrodes 12 and the second electrodes 13 are formed of a light-transmitting conductive material, such as indium tin oxide (ITO), indium zinc oxide (IZO), or the like.

As illustrated in FIG. 4, the first electrodes 12 and the second electrodes 13 are provided on the same surface of the first substrate 11 and are arranged in an area overlapping at least a display area AA of the display panel 50. The first electrodes 12 and the second electrodes 13 both extend in the second direction Dy and are alternately arranged in the first direction Dx at intervals. In other words, the arrangement is as follows: the first electrode 12, the second electrode 13, the first electrode 12, the second electrode 13, . . . in the first direction Dx. With this configuration, when a voltage is supplied to the first electrodes 12 and the second electrodes 13, a transverse electric field is generated between the first and second electrodes 12 and 13 in the first direction Dx.

Referring back to FIG. 3, the first orientation film 14 is provided on the upper side of the first substrate 11, covering the first electrodes 12 and the second electrodes 13. The first orientation film 14 is a vertically oriented film that vertically orients the liquid crystal molecules in the liquid crystal layer 15.

The second substrate 18 is placed facing the first substrate 11 and between the first substrate 11 and the second polarizing plate 22 in the third direction Dz. The second substrate 18 is a light-transmitting insulating substrate and is formed, for example, of glass or resin. In the present embodiment, no electrodes are provided in the second substrate 18. The second orientation film 17 is provided on the lower surface of the second substrate 18, that is, the surface of the second substrate 18 facing the first substrate 11. The second orientation film 17 has an orientation axis parallel to the first direction Dx formed by rubbing treatment, for example.

The liquid crystal layer 15 is provided between the first substrate 11 and the second substrate 18. More specifically, the liquid crystal layer 15 is provided between the first orientation film 14 and the second orientation film 17. The liquid crystal layer 15 includes liquid crystal molecules 16 with a positive dielectric anisotropy. The liquid crystal molecules 16 are rod-shaped having a long axis LA, and a dielectric constant ε1 in the direction along the long axis LA of the liquid crystal molecules 16 is greater than a dielectric constant ε2 in a short axis direction orthogonal to the long axis LA of the liquid crystal molecules 16 (ε1>ε2).

The liquid crystal molecules 16 in the liquid crystal layer 15 have hybrid orientation when no voltage is supplied to the first electrodes 12 and the second electrodes 13, that is, when the transverse electric field is not generated. The hybrid orientation refers to a state in which the liquid crystal molecules 16 having the long axis LA sandwiched between a pair of substrates are oriented so that the direction of the long axis LA is parallel to the substrate on one substrate side and perpendicular to the substrate on the other substrate side.

As illustrated in FIG. 3, the inclination angle formed between the long axis LA of the liquid crystal molecules 16 and the direction (e.g., the first direction Dx) parallel to the surface of the first substrate 11 varies continuously along the third direction Dz. In the state in which the liquid crystal molecules 16 have the hybrid orientation, the liquid crystal molecules 16 in the liquid crystal layer 15 on the first substrate 11 side each have the inclination angle formed to be relatively large and are oriented so as to be substantially perpendicular to the direction parallel to the surface of the first substrate 11. The liquid crystal molecules 16 in the liquid crystal layer 15 on the second substrate 18 side each have the inclination angle relatively small and are oriented so as to be substantially parallel to the direction parallel to the surface of the first substrate 11.

As illustrated in FIGS. 4 and 5, an orientation direction HX1 of the liquid crystal molecules 16 in plan view is along the first direction Dx. In other words, the orientation direction HX1 of the liquid crystal molecules 16 is provided along the arrangement direction of the first electrodes 12 and the second electrodes 13. The orientation direction HX1 of the liquid crystal molecules 16 is also arranged orthogonally to the first absorption axis AX1 of the first polarizing plate 21 and the second absorption axis AX2 of the second polarizing plate 22. Alternatively, the orientation direction HX1 of the liquid crystal molecules 16 may be arranged parallel to the first absorption axis AX1 of the first polarizing plate 21 and the second absorption axis AX2 of the second polarizing plate 22.

The control circuit 70 (see FIG. 1) changes the viewing angle of the first viewing angle control panel 20 by controlling the driving of the first electrodes 12 and the second electrodes 13. Specifically, in a state in which the control circuit 70 supplies no voltage to the first electrodes 12 and the second electrodes 13 (hereinafter referred to as “first state”), the liquid crystal molecules 16 of the liquid crystal layer 15 have the hybrid orientation as illustrated in FIG. 3. In a state in which the control circuit 70 supplies a voltage to the first electrodes 12 and the second electrodes 13 (hereinafter referred to as “second state”), the long axis LA of the liquid crystal molecules 16 of the liquid crystal layer 15 is oriented along the transverse electric field.

In other words, the liquid crystal layer 15 is switched between the first state in which the inclination angle formed between the long axis LA of the liquid crystal molecules 16 and the direction parallel to the surface of the first substrate 11 varies continuously along the direction perpendicular to the first substrate 11 and the second state in which the long axis LA of the liquid crystal molecules 16 is oriented in the direction along the transverse electric field.

With the above configuration, the optical element 10 controls the driving of the first electrodes 12 and the second electrodes 13 of the first viewing angle control panel 20. Thus, in the first state, the liquid crystal molecules 16 is caused to have the hybrid orientation, enabling an image with a narrower viewing angle to be displayed. In the second state, the liquid crystal molecules 16 is caused to be oriented in the direction substantially parallel to the surface of the first substrate 11, enabling an image with a wider viewing angle to be displayed.

Because the liquid crystal layer 15 includes the liquid crystal molecules 16 with a positive dielectric anisotropy, the liquid crystal layer 15 has lower viscosity than when liquid crystal molecules with a negative dielectric anisotropy are used, and has favorable response to voltage on/off switching. Because the first electrodes 12 and the second electrodes 13 are configured to generate a transverse electric field, the liquid crystal molecules 16 of the liquid crystal layer 15 are oriented in the direction substantially parallel to the surface of the first substrate 11 in the second state. Therefore, a viewing angle correcting filter, such as a C plate, is not needed, and the viewing angle can be controlled with a simpler configuration.

### Examples

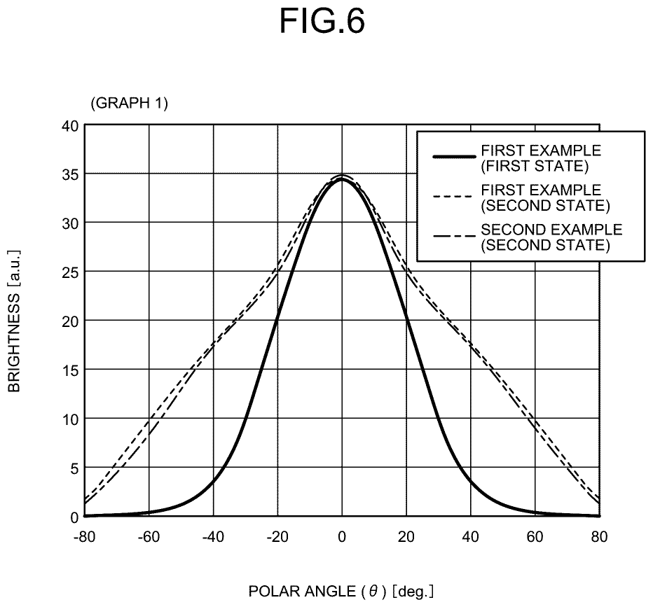

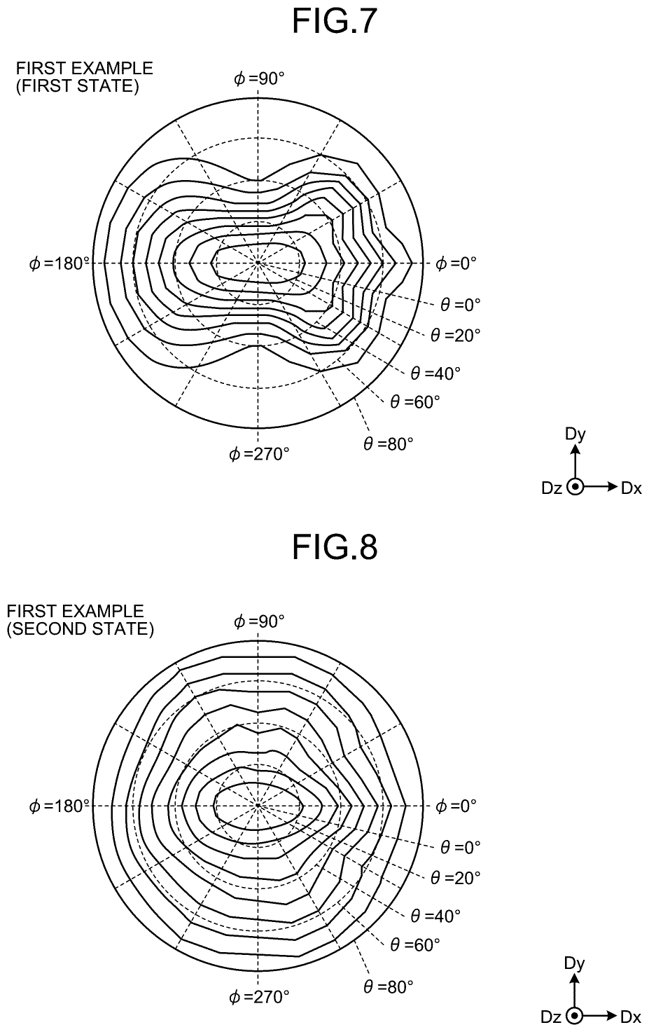

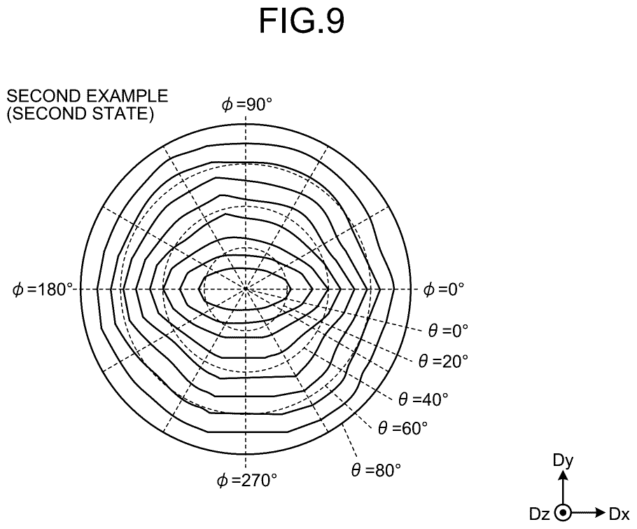

FIG. 6 is a graph illustrating the relation between the brightness and the polar angle in display devices according to a first example and a second example. FIG. 7 is a diagram illustrating viewing angle dependence of the brightness in the first state of the display device according to the first example. FIG. 8 is a diagram illustrating viewing angle dependence of the brightness in the second state of the display device according to the first example. FIG. 9 is a diagram illustrating viewing angle dependence of the brightness in the second state of the display device according to the second example.

Multi-layered configurations of the optical element 10 according to a first example and a second example are both similar to the example illustrated in FIGS. 1 through 5. The first example and the second example differ in an arrangement interval Px (see FIG. 4) between the first electrodes 12 and the second electrodes 13. In the first example, the arrangement interval Px between the first and second electrodes 12 and 13 adjacent to each other in the first direction Dx is 12 μm. In the second example, the arrangement interval Px between the first and second electrodes 12 and 13 adjacent to each other in the first direction Dx is 24 μm.

In Graph 1 illustrated in FIG. 6, the horizontal axis represents the polar angle θ (°) and the vertical axis represents the brightness (a.u.). FIG. 6 illustrates simulation results of the polar angle dependence of the relative brightness of the first example and the second example when the brightness in the frontal direction (polar angle θ=0°) is equal.

FIGS. 7 through 9 illustrate isophotes connecting regions of equal brightness for each polar and azimuth angle. In FIGS. 7 through 9, an azimuth angle φ is the angle made with respect to the direction parallel to the first direction Dx. In each of FIGS. 7 through 9, the azimuth angle φ=0° on the right side (one side of the first direction Dx) with respect to the center of the circle, and the azimuth angle φ=180° on the left side (the other side of the first direction Dx) with respect to the center of the circle. The azimuth angle φ=90° on the upper side (one side of the second direction Dy) with respect to the center of the circle, and the azimuth angle φ=270° on the lower side (the other side of the second direction Dy) with respect to the center of the circle. The center of the circle corresponds to the normal direction (polar angle θ=0°) of the display device 100 (optical element 10), and concentric circles (illustrated by dotted lines) centered on the normal direction correspond to polar angles θ=20°, 40°, 60°, and 80°. Graph 1 in FIG. 6 illustrates the polar angle dependence in the second direction Dy (direction from the azimuth angle φ=90° to the azimuth angle φ=270°).

As illustrated in FIG. 6, in the first example, the brightness is held low on the high pole angle side in the first state in which no voltage is supplied to the first electrodes 12 and the second electrodes 13. Specifically, in the first state, the brightness is held low in the range of the polar angle θ=−50° or less and the polar angle θ=50° or more.

As illustrated in FIG. 7, the first example has an azimuth dependence of the brightness in the first state. Specifically, the first example in the first state has a wide viewing angle in the first direction Dx (direction from the azimuth angle φ=0° to the azimuth angle φ=180°). In contrast, the first example in the first state has a narrow viewing angle in the second direction Dy (direction from the azimuth angle φ=90° to the azimuth angle φ=270°).

As illustrated in FIG. 6, in the first example, the second state in which a voltage is supplied to the first electrodes 12 and the second electrodes 13 can achieve a wider viewing angle than the first state. Specifically, the second state is brighter than the first state for most of the polar angles θ except for the polar angle θ=0°. In particular, in the second state, the contrast ratio to the brightness of the first state is large at and near the polar angle θ=−50° and the polar angle θ=50°.

As illustrated in FIG. 8, the first example can achieve a wide viewing angle at all azimuth angles φ in the second state. In the second state in the first example, the azimuth dependence of the brightness has symmetry. Specifically, the second state in the first example provides a viewing angle dependence of the brightness that is substantially line symmetric with respect to a reference line that passes through the polar angle θ=0° and is parallel to the second direction Dy. The second state in the first example provides a viewing angle dependence of the brightness that is substantially line symmetric with respect to a reference line that passes through the polar angle θ=0° and is parallel to the first direction Dx.

Thus, the azimuth angle φ=0° and 180° direction of the optical element 10 are arranged in the up and down direction of the display device 100. With this configuration, in the first state, the display device 100 of the first example can achieve a narrow viewing angle that makes an image invisible from the left and right direction while ensuring image brightness in the frontal direction (polar angle θ=0°). In the second state, the display device 100 of the first example can achieve a wide viewing angle that allows an image to be viewed from the frontal direction and the left and right direction.

In FIG. 6, the polar angle dependence of the brightness in the first state of the second example is omitted. However, in the first state in which no voltage is supplied to the first electrodes 12 and the second electrodes 13, the polar angle dependence of the brightness in the second example is substantially equal to the polar angle dependence of the brightness in the first example.

As illustrated in FIGS. 6 and 9, in the second state in which a voltage is supplied to the first electrodes 12 and the second electrodes 13, a viewing angle dependence of the brightness in the second example is substantially equal to that in the second state in the first example. In other words, the second state in the second example can also achieve a wider viewing angle than the first state.

As illustrated in the first and second examples, even in cases deferring in the arrangement interval Px between the first and second electrodes 12 and 13, the viewing angle can be controlled with the first and second states. As illustrated in FIGS. 8 and 9, in the second state in which a voltage is supplied to the first electrodes 12 and the second electrodes 13 in the first and second examples, the polar angle dependence is such that the brightness varies continuously in the oblique direction (e.g., azimuth angle φ=+45°) with respect to the polar angle θ=0°. The second state does not provide such brightness distribution as to be locally brightened or locally darkened. Therefore, it has been illustrated that favorable image display can be achieved without providing a viewing angle correcting filter, such as a C plate, in the first and second examples.

The first embodiment and the examples described above are merely examples and can be modified as appropriate. For example, the arrangement interval Px between the first and second electrodes 12 and 13 is not limited to 12 μm or 24 μm. The first and second electrodes 12 and 13 may be of any shape and arrangement as long as they are configured to generate a transverse electric field.

### First Modification

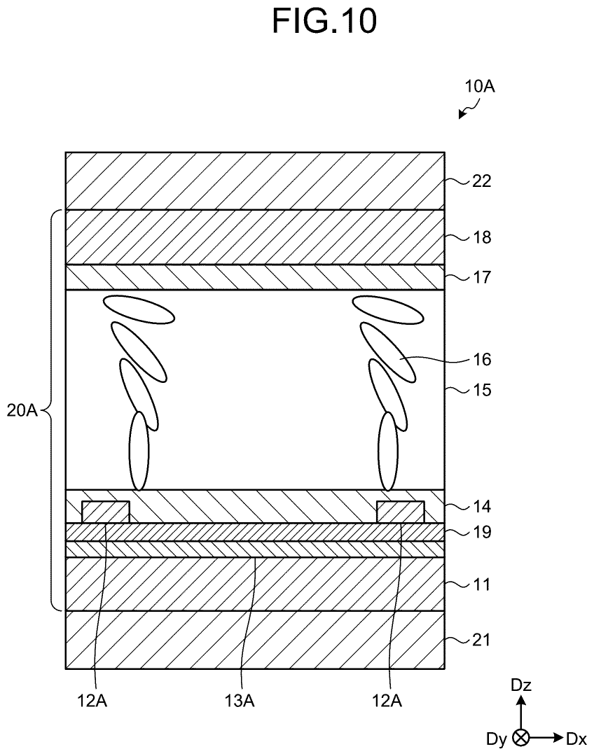

FIG. 10 is a sectional view schematically illustrating an example of a configuration of an optical element according to a first modification. In the following description, the same reference signs are given to the same components as those described in the above embodiments, and duplicated description is omitted.

As illustrated in FIG. 10, an optical element 10A according to the first modification differs from that of the first embodiment described above in the configuration of a first electrode 12A and a second electrode 13A of a first viewing angle control panel 20A. Specifically, the second electrodes 13A are provided on the surface of the first substrate 11 facing the second substrate 18. An insulating film 19 is provided to cover the second electrode 13A. A plurality of the first electrodes 12A are provided on the upper side of the insulating film 19. In the third direction Dz, the first substrate 11, the second electrode 13A, the insulating film 19, and the first electrodes 12A are stacked in this order.

The second electrode 13A is supplied with a predetermined reference potential and is provided as a common electrode for the first electrodes 12A. In FIG. 10, one second electrode 13A is provided for the first electrodes 12A. However, the number of the second electrode 13A is not limited thereto, and a plurality of the second electrodes 13A may be provided.

With this configuration, when a voltage is supplied to the first electrodes 12A and the second electrode 13A, a fringe electric field is generated between the first and second electrodes 12A and 13A. In the first modification, the liquid crystal molecules 16 in the liquid crystal layer are driven by the fringe electric field formed between the first and second electrodes 12A and 13A.

### Second Modification

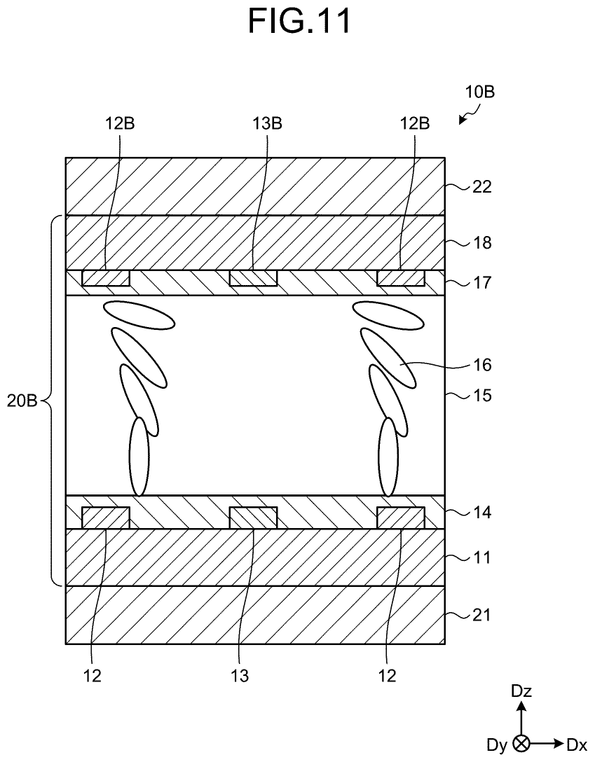

FIG. 11 is a sectional view schematically illustrating an example of a configuration of an optical element according to a second modification. As illustrated in FIG. 11, an optical element 10B according to the second modification differs from the first embodiment described above in the configuration in which electrodes are provided on both of the first substrate 11 and the second substrate 18 of a first viewing angle control panel 20B. Specifically, the first electrodes 12 and the second electrodes 13 are provided on the surface of the first substrate 11 facing the second substrate 18 and are alternately arranged in the first direction Dx. Furthermore, a plurality of first electrodes 12B and a plurality of second electrodes 13B are provided on the surface of the second substrate 18 facing the first substrate 11, and are alternately arranged in the first direction Dx.

The first electrodes 12B provided on the second substrate 18 are each placed to overlap with the respective first electrodes 12 on the first substrate 11. The second electrodes 13B provided on the second substrate 18 are each placed to overlap with the respective second electrodes 13 on the first substrate 11.

With this configuration, when a voltage is supplied to the first electrodes 12, 12A and the second electrodes 13, 13A, a transverse electric field is generated between the first and second electrodes 12 and 13 and between the first and second electrodes 12A and 13A. In the second modification, the liquid crystal molecules 16 in the liquid crystal layer 15 are driven by the transverse electric field formed between the first and second electrodes 12 and 13 and between the first and second electrodes 12B and 13B.

### Second Embodiment

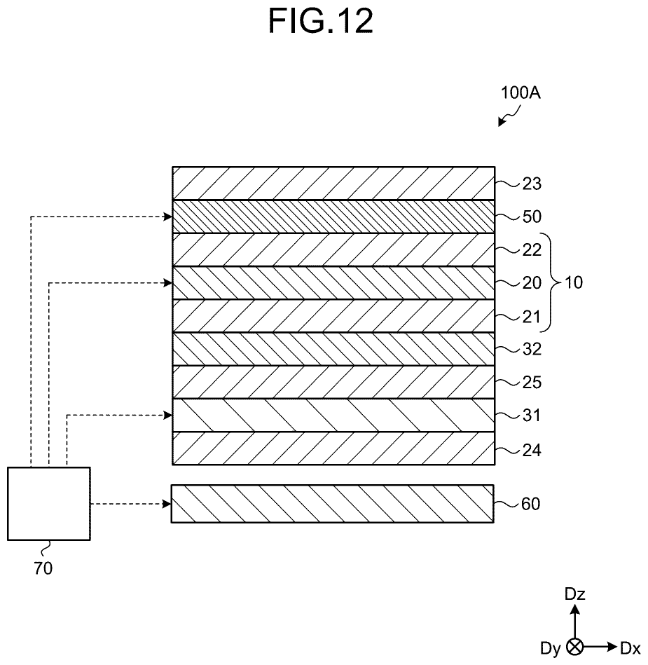

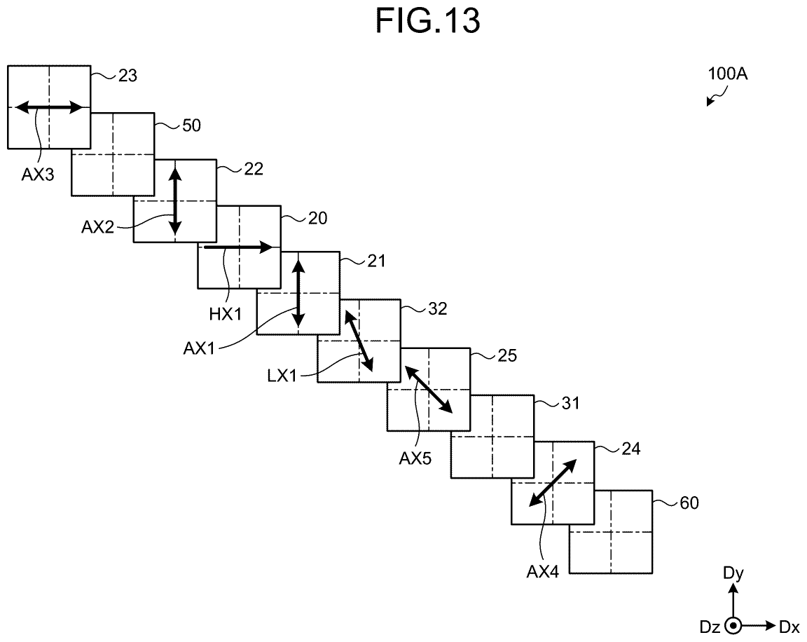

FIG. 12 is a sectional view schematically illustrating a display device according to a second embodiment. FIG. 13 is a diagram for explaining the relation between the direction of absorption axes of the polarizing plates and the direction of orientation of the liquid crystal layer of the first viewing angle control panel in the display device according to the second embodiment.

As illustrated in FIGS. 12 and 13, a display device 100A according to the second embodiment further includes a fourth polarizing plate 24, a second viewing angle control panel 31, a fifth polarizing plate 25, and a half-wave plate 32. The fourth polarizing plate 24, the second viewing angle control panel 31, the fifth polarizing plate and the half-wave plate 32 are stacked in this order between the lighting device 60 and the optical element 10.

The second viewing angle control panel 31 includes a TN-type liquid crystal layer. In other words, in the second viewing angle control panel 31, orientation treatment is applied to upper and lower orientation films, whereby liquid crystal molecules in a liquid crystal layer are oriented so as to be continuously twisted 90° between the upper and lower substrates in plan view. The half-wave plate 32 provides a phase difference of half wavelength to the transmitted light.

As illustrated in FIG. 13, a fourth absorption axis AX4 of the fourth polarizing plate 24 is arranged orthogonally to a fifth absorption axis AX5 of the fifth polarizing plate 25. The fifth absorption axis AX5 of the fifth polarizing plate 25 is arranged with an azimuth angle φ=45° with respect to the first absorption axis AX1 of the first polarizing plate 21 of the optical element 10. A stretching axial direction LX1 of the half-wave plate 32 is a midway direction between the first absorption axis AX1 of the first polarizing plate 21 and the fifth absorption axis AX5 of the fifth polarizing plate 25. With this configuration, the second embodiment can properly adjust the polarization state of light incident on the first polarizing plate 21 of the optical element 10.

### Third Modification of Second Embodiment

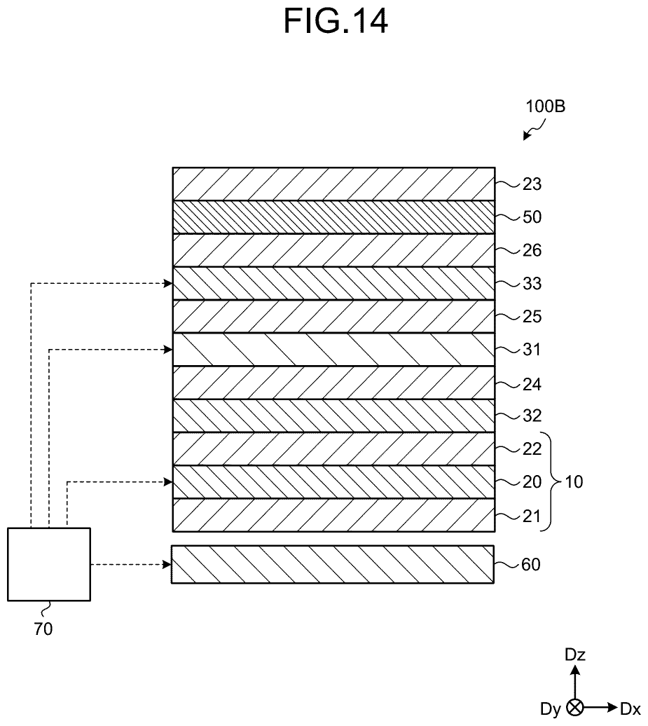

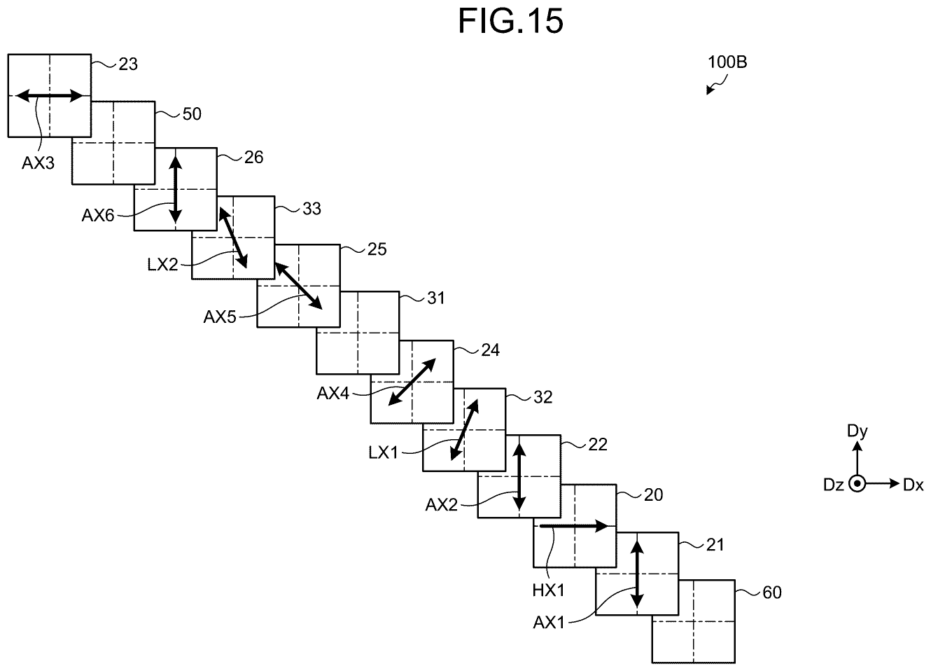

FIG. 14 is a sectional view schematically illustrating a display device according to a third modification of the second embodiment. FIG. 15 is a diagram for explaining the relation between the direction of absorption axes of the polarizing plates and the direction of orientation of the liquid crystal layer of the first viewing angle control panel in the display device according to the third modification of the second embodiment.

As illustrated in FIGS. 14 and 15, a display device 100B according to the third modification of the second embodiment includes the half-wave plate 32, the fourth polarizing plate 24, the second viewing angle control panel 31, the fifth polarizing plate 25, a half-wave plate 33, and a sixth polarizing plate 26 stacked in this order between the optical element 10 and the display panel 50.

As illustrated in FIG. 15, the fourth absorption axis AX4 of the fourth polarizing plate 24 is arranged with an azimuth angle φ=45° with respect to the second absorption axis AX2 of the second polarizing plate 22 of the optical element 10. The stretching axial direction LX1 of the half-wave plate 32 is a midway direction between the second absorption axis AX2 of the second polarizing plate 22 and the fourth absorption axis AX4 of the fourth polarizing plate 24. The fifth absorption axis AX5 of the fifth polarizing plate 25 is arranged orthogonally to the fourth absorption axis AX4 of the fourth polarizing plate 24. The fifth absorption axis AX5 of the fifth polarizing plate 25 is arranged with an azimuth angle φ=45° with respect to the sixth absorption axis AX6 of the sixth polarizing plate 26. A stretching axial direction LX2 of the half-wave plate 33 is a midway direction between the fifth absorption axis AX5 of the fifth polarizing plate 25 and the sixth absorption axis AX6 of the sixth polarizing plate 26. With this configuration, the third modification of the second embodiment can properly adjust the polarization state of light transmitted through the optical element 10 and incident on the display panel 50.

The configuration with the optical element 10 illustrated in the first embodiment has been described in the second embodiment and the third modification. However, the configuration is not limited thereto, and the optical element 10A or 10B according to the first or second modification can also be combined in the second embodiment and the third modification.

Although the preferred embodiments of the present disclosure have been described, the embodiments do not limit the present disclosure. What has been disclosed in the embodiments is merely an example, and various modifications may be made without departing from the spirit of the present disclosure. As may be understood, any modification made as appropriate without departing from the spirit of the present disclosure is also included in the technical scope of the present disclosure. At least one of various omissions, substitutions, and modifications of the components can be made without departing from the spirit of the embodiments and modifications described above.

What is claimed is:

1. An optical element comprising:
a first polarizing plate having a first absorption axis;
a second polarizing plate facing the first polarizing plate and having a second absorption axis; and
a first viewing angle control panel placed between the first polarizing plate and the second polarizing plate,
wherein the first viewing angle control panel comprises:
a first substrate;
a second substrate facing the first substrate;
a liquid crystal layer provided between the first substrate and the second substrate; and
a plurality of electrodes provided on at least one of the first substrate and the second substrate to generate a transverse electric field in a predetermined direction,
wherein the liquid crystal layer comprises liquid crystal molecules with a positive dielectric anisotropy, and
wherein the liquid crystal molecules have hybrid orientation in a state in which the transverse electric field is not generated.

2. The optical element according to claim 1,
wherein the first polarizing plate, the first substrate, the liquid crystal layer, the second substrate, and the second polarizing plate are stacked in the order as listed,
wherein the first absorption axis of the first polarizing plate is arranged parallel to the second absorption axis of the second polarizing plate in plan view, and
wherein an orientation direction of the liquid crystal molecules is arranged so as to be parallel or orthogonal to the first absorption axis of the first polarizing plate and the second absorption axis of the second polarizing plate.

3. The optical element according to claim 1, wherein the liquid crystal layer is switched between a first state in which an inclination angle formed between a long axis of the liquid crystal molecules and a direction parallel to a surface of the first substrate varies continuously along a direction perpendicular to the first substrate and a second state in which the long axis of the liquid crystal molecules is oriented in a direction along the transverse electric field.

4. The optical element according to claim 1,
wherein the electrodes comprise a plurality of first electrodes and a plurality of second electrodes, and
wherein the first electrodes and the second electrodes are provided on a surface of the first substrate facing the second substrate and are alternately arranged in the predetermined direction.

5. The optical element according to claim 1,
wherein the electrodes comprise a plurality of first electrodes and a plurality of second electrodes, and
wherein the first electrodes and the second electrodes are provided on a surface of the first substrate facing the second substrate and are alternately placed in the predetermined direction, and also, are provided on a surface of the second substrate facing the first substrate, and are alternately placed in the predetermined direction.

6. The optical element according to claim 1,
wherein the electrodes comprise a plurality of first electrodes and at least one second electrode, and
wherein the at least one second electrode, an insulating film, and the first electrodes are stacked in the order as listed, on a surface of the first substrate facing the second substrate.

7. A display device comprising:
the optical element according to claim 1;
a display panel stacked with the optical element; and
a lighting device configured to irradiate the optical element with light.

8. The display device according to claim 7, further comprising a second viewing angle control panel comprising a TN-type liquid crystal layer,
wherein the second viewing angle control panel is placed between the lighting device and the optical element.

9. The display device according to claim 7, further comprising a second viewing angle control panel comprising a TN-type liquid crystal layer,
wherein the second viewing angle control panel is placed between the optical element and the display panel.
